(19) United States
(12) Patent Application Publication
(10) Pub. No.: US 2018/0198869 A1
(43) Pub. Date: Jul. 12, 2018

(54) SYSTEM, APPARATUS AND METHOD FOR CONNECTING TWO OR MORE USERS

(71) Applicant: YAPAPP INDIA PRIVATE LIMITED, Punjab (IN)

(72) Inventors: Pankaj Arora, Punjab (IN); Avi Shaked, St.Savlon (IL)

(21) Appl. No.: 15/618,694

(22) Filed: Jun. 9, 2017

(30) Foreign Application Priority Data
Jan. 12, 2017 (IN) 201711001369

(51) Int. Cl. H04L 29/08; G06K 9/62

(52) U.S. Cl. CPC H04L 67/141; H04L 67/42; G06K 9/6202

(57) ABSTRACT

Embodiments of the present disclosure provides a system for connecting users over a network without requiring the users to share their personal contact details. The system comprises a server, a first user device, and a second user device, wherein the first user device is configured to upload a first image to the server and the second user device is configured to upload a second image to the server. Thereafter, the server compares the first image and the second image to identify if both the images are same images. If the server identifies that both the images are same images, then the server enables the first user device and the second user device to communicate with each other over a platform hosted by the server.

### FIELD OF THE INVENTION

Embodiments of the present invention in general, concern a system, apparatus, and method to connect and enable communication between two or more users. More particularly, embodiments of the present invention concern to a system, apparatus, and method for connecting two or more users without using their contact details.

### BACKGROUND OF THE INVENTION

Various developments in the domain of mobile communication and internet allow multiple users to connect with each other. Connecting two or more users using various different methods and tools is well known in the art. One popular form of communication tool is using messaging apps which allows instant communication among the users. Such messaging apps also include various functionalities such as text messaging, video calling, audio calling, etc.

Messaging apps known in the art suffer from several shortcomings, one being that a user is required to have the personal contact details of second user for communicating with him, but sometimes people are not comfortable sharing their personal details with each other.

To overcome this shortcoming, other methods are proposed in the art to enable the anonymous communication with the users. However, most of these anonymous communication methods are based on randomly connecting multiple users depending on the parameters common to users wherein the parameters can be, such as, but not limited to, interests, hobbies, affinity of the users, etc. However, the purpose of connecting two people who know each other without sharing their contact details is not solved by such methods. Other known messaging apps connect two or more users based on their proximity with each other, however such connections may not interest everyone and may also be threatening to the security of the users.

Hence, it is apparent that a need exists for a technique that decimates the above mentioned problems of the prior art and provides an improved method for connecting two or more users without requiring them to share any information.

The applicant has devised, tested and embodied the present invention to overcome the shortcomings of the state of the art and to obtain these and other purposes and advantages.

### SUMMARY OF THE INVENTION

It is an object of the invention to provide a system and method for connecting users without requiring them to register with the system and share their personal details.

It is further object of the present invention to provide a user device with capabilities to connect multiple users without using their personal contact details. The user device can have functionality of the present invention pre-installed and there will be no need to install any software or application program separately to perform the functions of the present invention.

It is further object of the present invention to provide an application program which can be installed on a user device to communicate with other users without sharing their personal contact details.

It is further object of the present invention to enable users to communicate with each other by uploading an image. Each user uploads an image on a remote server using an application program running on the respective user device. The uploaded images are compared using an image recognition service (IRS) for determining whether a communication should be established between the users or not. In case, the image recognition service (IRS) determines that the uploaded images are matching and same, then a connection is established between the users who uploaded the matching images and the connected users can communicate with each other using various communication methods, such as, but not limited to, voice calling, chatting, media sharing, video calling, etc.

It is further object of the invention to provide a system and a method to allow users to connect directly with customer care representatives of a company by uploading an image associated with the company on a remote server of the present invention. Multiple companies can register on the remote server of the present invention by uploading their brand images, such as, and without limitation to, logos, trademarks, or other unique images representing the company. Brand images associated with various products and services of the company (e.g. logos, trademarks, etc) can be shared using various mediums such as, but not limited to, social media platform, advertisements, company website, printing the image on product packaging, brochures, etc. When a user wants to contact customer representative, the user can upload the associated brand image on the remote server via the application program running on the user device in order to reach the customer care executive. Further, companies can register multiple brand images associated with various departments/products/services of the company to enable the user to directly contact with the concerned department by uploading the various brand images. For example, if a company Z has registered two brand images A and B namely on the remote server of the present invention, then if a user also uploads the brand image A on the remote server using the user device then he will be connected with customer care or troubleshooting department associated with brand A of the company Z.

Further object of the invention is to provide a system and a method where a user can listen to the live feeds/podcasts of various music or radio stations or can view the various videos of other users, by uploading images associated with various feeds/podcasts on a remote server.

Further object of the invention is to provide a system and a method where money can be transferred by using images. In this scenario, the application program can function as a wallet. According to an embodiment, the images act as Virtual Payment address for a user to accept payments. This will add a layer to the security of banking system as user does not have to share any bank details or mobile number during a transaction.

Further object of the invention is to create a profile of a user by facial recognition of the user and then use this facial pattern for creating his/her connections.

Further object of the invention is to allow users to send messages to their connections. Users can also send a variety of emoticons while messaging. Further, users can also communicate using video calling and voice calling features. User can edit videos during runtime by changing faces (e.g. funny faces) using various face recognition algorithms. Also, users can record a Voice Message and send the recorded message in the chat.

Further object of the invention is to enable users to share photos and videos instantly among other users. Users can even capture the moments with a built-in camera. Using present invention, user can send photos and videos quickly even on a slow connection. Users can also share PDFs, documents, spreadsheets, presentations, etc. to one or more connections without using any file sharing apps or emails.

It is another object of the invention to provide end-to-end encryption for enabling secure communication between users so that no unauthorized person can read or listen to conversations.

Further object of the invention is to allow a group of people to connect using a same image and communicate with each other.

Further object of the invention is to allow famous personalities or celebrities to upload an image and post their updates and related content on that image. Public users can join the image to get all the updates related to that image by uploading it on remote server. Thus, celebrities can use the images for promotion purposes and connecting with their followers.

Further object of the invention is to enable a user to communicate using multiple user devices. The present invention allows a user to sync contact information with other user devices associated with the user, and thus the user can communicate with others users using the other user devices associated with the user.

Further object of the invention is to use an image as a new identity of a user for connecting with the user rather than using the traditional known identities associated with the user, such as, but not limited to, name, email ID, phone numbers, and unique numbers etc. Therefore, there is no need to save contacts details of the users (i.e. phone number/emails, etc.) and images can be used for connecting with the users.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an exemplary environment for connecting multiple users without using their personal contact details in accordance to an embodiment of the present invention;

FIG. 2 illustrates a block diagram of a user device in accordance with an embodiment of the present invention;

FIG. 3 is a flowchart illustrating an exemplary workflow for connecting two or more people without using their personal contact details according to the present invention;

FIG. 4 is a flowchart illustrating an exemplary workflow for connecting two or more people without using their personal contact details according to the further aspects of the present invention;

FIG. 5 is a block diagram illustrating second embodiment of the present invention for connecting users with customer care representatives of a company;

FIG. 6 discloses a method for connecting users to call center/customer care department of a company without using their personal contact details according to the second embodiment of the present invention;

FIG. 7 discloses a step wise flow for creating a social media group in accordance with the present invention;

FIG. 8 shows the flow diagram for connecting celebrities with fans and followers in accordance with the present invention;

FIG. 9 shows the flow diagram for making payments in accordance with the present invention;

FIG. 10 shows the flow diagram of another embodiment for making payments in accordance with another embodiment of present invention;

FIG. 11 discloses a flow diagram for connecting users to the live feed of the various music and radio stations/podcasts according to the present invention.

### DETAILED DESCRIPTION OF THE PREFERRED EMBODIMENT

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

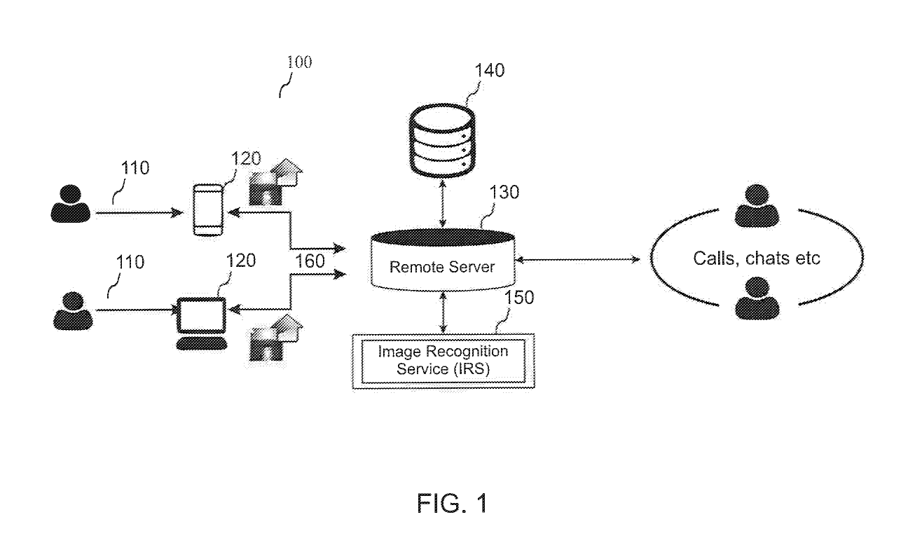

FIG. 1 discloses an exemplary environment 100 for connecting two or more people without using their personal contact details in accordance with first embodiment of the present invention. The environment 100 comprises a user device 120 and a remote server 130 connected to each other through a communication link 160.

Further, the user device 120 refers to a device which is used by the users 110 to connect with each other, and access the remote server 130. The user device 120 can be such as, but not limited to, a smart phone, a hand-held phone, a personal digital assistant (PDA), a tablet computer, a desktop computer, a smart TV, a smart wearable device, a laptop computer, or other similar device without departing from the spirit and scope of the present invention.

The remote server 130 mentioned in the present invention refers to a server which is configured to provide various functionalities of the present invention and is utilized for connecting the two or more users without requiring them to share any personal details. According to an embodiment, the server is configured to provide various functionalities of the present invention with execution of a set of instructions, stored on a memory, by a processor. Further, the communication link 160 can be such as, but not limited to, Wi-Fi, cellular network, Local Area Network (LAN), Wide Area Network (WAN), Metropolitan Area Network (MAN), PSTN, internet, GPRS, GSM, CDMA network, Ethernet, fiber optics, and so forth.

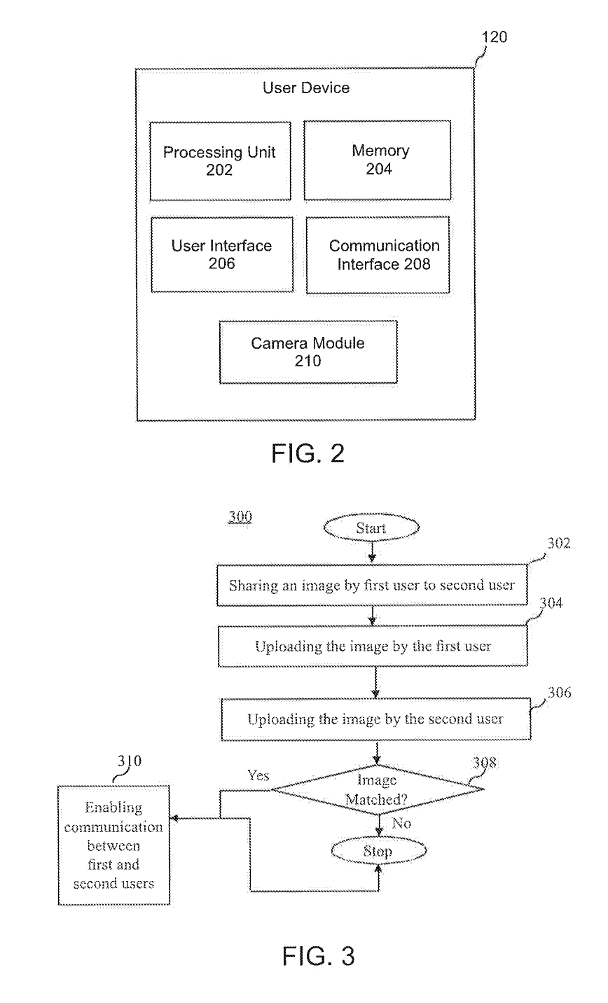

The remote server 130 further comprises a database 140 and an image recognition service (IRS) 150. In the preferred embodiment of the present invention, the database 140 and IRS 150 are integral part of the remote server 130. In an another embodiment, the database 140 and IRS 150 are not the integrated inside the remote server 130 and are implemented externally. More details on the functioning of the devices 120 and 130 are provided further in conjunction with FIG. 2 and FIG. 3, respectively, of the present invention.

FIG. 2 shows a block diagram of user device 120 in accordance with preferred embodiment of the present invention. The user device 120 comprises a processing unit 202 for performing various functions of the user device 120. The user device 120 further comprises a memory 204 which stores an application program and user data. In an embodiment, the application program can be operated in multiple languages.

The processing unit 202 interacts with the memory 204 to execute the instructions stored on the memory 204 to run the application program to perform various functionalities according to the various embodiments of the present invention. In the preferred embodiment of the present invention, the memory 204 is internal and non removable memory. According to another embodiment of the present invention, the memory 204 is a removable memory. The memory can be such as, but not limited to, volatile memory, non volatile memory, RAM, DRAM, SRAM, ROM, EPROM, EEPROM, hard drive, magnetic memory, optical memory, flash memory, USB storage, data card, SD card, or any other memory known in the prior art.

In one embodiment of the present invention, the application program is downloaded from the internet and it is installed on the user device 120. In another embodiment of the present invention, the application program is pre-installed or in-built in the user device 120.

The user device 120 comprises a communication interface 208 for performing communication with other user devices 120 and remote server 130. The communication interface 208 can be such as, but not limited to, Ethernet port, Bluetooth, WiFi, LAN interface, NFC, Zigbee, Infrared port, cellular interface, radio interface, fiber optic port, or any other method known in the prior art.

The user interacts with the user device 120 through user interface 206 as shown in the FIG. 2. The user interface 206 can be any interface known in the art, such as, Graphical User interface, touchscreen, keyboard, mouse, keypad, and combinations thereof.

In one embodiment of the present invention, the user device 120 comprises a camera module 210 such as, but not limited to, a digital camera, a webcam, etc. The camera module 210 is capable of capturing images of an object. The camera module 210 can be internal or external to the user device 120.

The method for connecting two or more people without using their personal contact details according to the present invention is illustrated by flow 300 of FIG. 3. Process starts at step 302, where a first user shares an image with a second user. According to the preferred embodiment of the present invention, the image shared is unique and exclusive to the first user. The first user can share the image using various methods know in prior art such as, but not limited to, Bluetooth, WiFi, Cloud, NFC, AirDrop, other short or long distance image sharing techniques.

In another embodiment of the present invention, image can also be transferred by sharing the hyperlink of the storage location of the image wherein the storage location of the image is remote server 130.

In another embodiment of the present invention, an image can be shared by scanning a data matrix code associated with the image. In this image sharing method, the first user uploads the image on the remote server using the application program running on the first user device 120 and in response to the uploading, the remote server 130 generates a data matrix code associated with the uploaded image. The generated data matrix code is displayed in the graphical user interface of the application program running on the first user device 120. The second user scans the data matrix code displayed on the user device of the first user wherein the data matrix code can be scanned using the methods known in the art, such as, but not limited to, using the camera module of the second user device. The scanning of the data matrix code provides a hyperlink for downloading the uploaded image. After scanning the matrix code, image is transferred from the remote server to the second user device. The matrix code can be such as, but not limited to a QR code, a barcode, or or any other data containing code known to an ordinary skilled in the art.

At step 304, the first user uploads the image to the remote server 130 using application program running on the user device associated with the first user. According to an embodiment, the first user can upload the image to the server prior to sharing the image with the second user. After receiving the image from the first user in step 302, the second user also uploads the same image to the remote server 130 using application program running on the user device associated with the second user at step 306. The user devices communicate with remote server 130 over wired or wireless communication links 160. After receiving images from both users, the remote server 130 stores images in database 140 for further operations and processing.

In step 308, the images are transferred to the Image Recognition Service (IRS) 150. The IRS 150 analyses both of the images and checks whether the uploaded images by the first user and the second user are exactly same. The results of IRS 150 are communicated to the remote server 130. If the images uploaded in the step 304 & 306 are different then server terminates the whole process and users are not allowed to communicate. If the uploaded images are exactly same, then users are allowed to communicate over various communication methods. After it has been established that the uploaded images are exactly same, the connection is established between the first user and second user in step 310. The users can communicate using the user devices through remote server 130. The users can communicate over communication methods including but not limited to voice calling, video calling, VOIP calling, voice messaging, chatting, text messaging, or email. The connection established between the users is secured using end to end encryption which means that no third party or person is able to read or listen to the conversation of the users. Further, users can use various emoticons to enhance the messaging experience.

In another embodiment of the present invention, once a connection is established the users also can share media and documents with each other. Also, users can share their location with each other after the connection is established.

In an embodiment of the present invention, once the connection is successfully established, the users can communicate with each other using the video calling feature of present invention. During the video calling session, users can be provided with an option to mask their face. Any known methods, such as, but not limited to, blurring the user's face, putting virtual masks, adding funny faces, changing the characteristics of the face virtually, etc. can be used to mask the user's face.

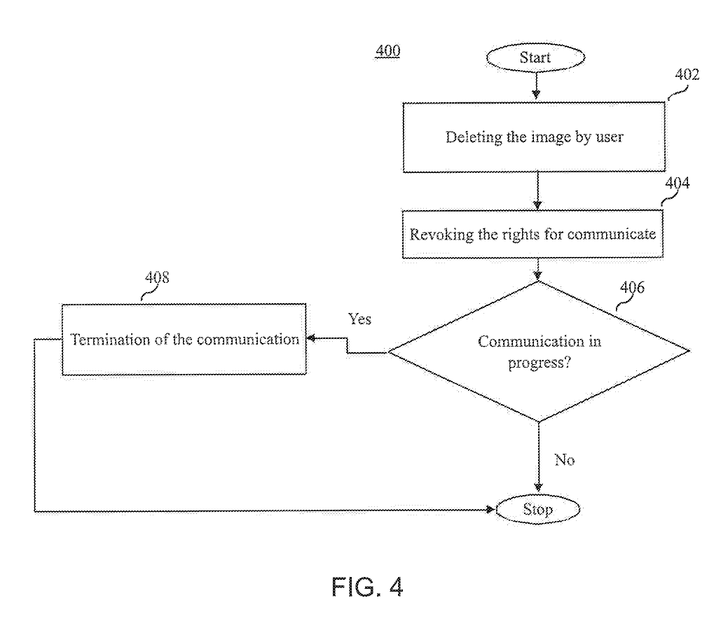

The method for connecting two or more people without using their personal contact details according to the present invention is further illustrated by flow 400 of FIG. 4. In the preferred embodiment, a provision is given to users to terminate the connection. A user can terminate the communication with other user by simply deleting the uploaded image from the remote server. In the preferred embodiment, any of the first user or second user can terminate the communication by deleting the image. After the image is deleted, remote server 130 revokes the rights for communication of both users, as shown in step 404. At step 406, after revoking the rights, remote server 130 checks if the communication is in progress. If communication is in progress, then flow goes to step 408. At step 408, communication is terminated between the users and the users are disconnected from each other. If communication is not in progress, then process stops and users are disconnected.

In an embodiment, an icon is provided on the user interface 206 (shown in FIG. 2) to terminate the connection. Other methods as known in prior art can also be used for termination of the connection.

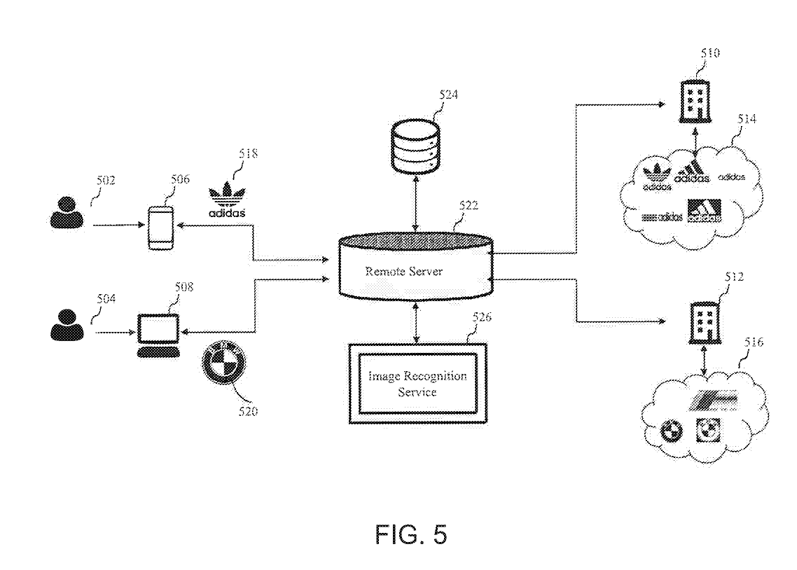

FIG. 5 discloses another embodiment of the present invention, where users 502 and 504 interact with a company or an organization, without dialing their customer care number, by using an application program running on user devices 506 and 508, respectively. Each company creates one or more brand images of their products/portals wherein the brand images can be, such as, and without limitation to, logos, brand images, trademarks, or other unique images representing the company/products/services. As shown in FIG. 5, company 510 registers on the remote server 522 by uploading one or more brand images 514 wherein, the brand images are associated with different products or services of the company. The first user 502 contacts the call center of company 510 by uploading an image 518 of the same brand using the user device 506. The image 518 is uploaded to the remote server 522 where it is stored in the database 524. The remote server 522 compares the image 518 to the multiple images 514 uploaded on the remote server 522. The Image Recognition Service (IRS) 526 in the remote server 522 is responsible for comparison of the images. If the image 518 exactly matches one of the multiple images 514 associated with the company 510, then a connection is established between the user 502 and the company 510.

In an embodiment of the present invention, the image 518 is substantially same to the one of the multiple images 514. The IRS 526 compares if the images are considerably similar i.e. the images are not exactly same. A criteria known in the prior art can be used to evaluate the similarity of the images. For example, if result of comparison of two images is above a certain threshold value, then communication can be established. Threshold value can be used to mitigate or compensate the effect of minor differences in the images while matching. Differences in the images can be such as, but not limited to, minor color variations, change in orientation of the images, pixel differences due to compression or transmission of images, angle variations, etc.

In preferred embodiment of the present invention, the voice call is established between the user 502 and the company 510. In other embodiment of the present invention, mode of communication established can be, but not limited to, video call, message, chat, or email.

A similar process is followed for connecting the second user 504 with the customer care representative of the second company. The second user 504 contacts the call center of company 512 by uploading an image 520 of the same brand using the user device 508. The image 520 is uploaded to the remote server 522 where it is stored in the database 524. The remote server 522 compares the image 522 to the multiple images 516 uploaded by the second company 512. The Image Recognition Service (IRS) 526 in the remote server 522 is responsible for comparison of the images. If the image 518 exactly matches or are substantially similar to one of the multiple images 514, then connection is established.

In an embodiment of the present invention, more than two users are able to communicate to the customer care representatives of the company. Further, more than two companies are also able to upload the images and are able to communicate to the users.

In an embodiment of the present invention, companies can register multiple brand images associated with various departments/products/services of the company to enable the user to directly contact with the concerned department by uploading the various brand images. For Example, if a company Z has registered two brand images A and B namely on the remote server of the present invention, then if a user also uploads the brand image A on the remote server using the user device then he will be connected with customer care or troubleshooting department associated with brand A of the company Z.

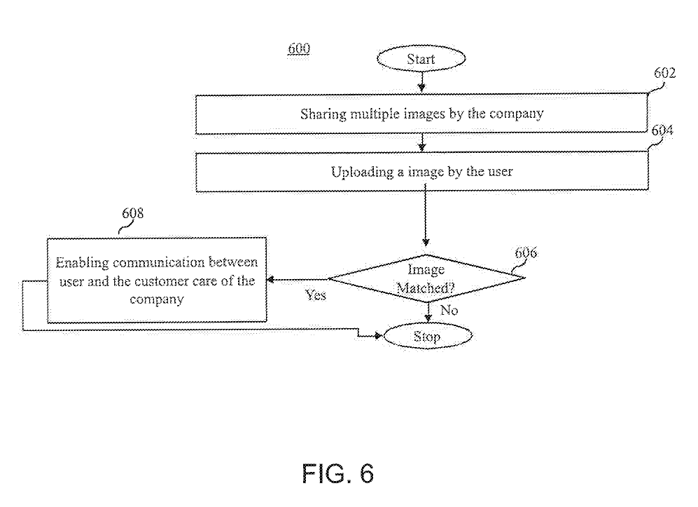

FIG. 6 discloses a method for connecting users to the call center/customer care of the company without using their personal contact details according to the present invention as illustrated by flow 600. At step 602, the company uploads one or more images of its brands or products. These images are uploaded to the remote server 522 and stored in the database 524. At step 604, a user uploads an image of a brand or product. After uploading the image by the user, remote server 522 stores that image in its database 524. Then the image uploaded by the user is compared to the multiple images in the remote server 522. The comparison of images is achieved by IRS 526 at step 606. If there is a substantial similarity between the image uploaded by the user and the company, then flow proceeds to step 608. At 608, communication is established between a user and customer care or call center of that company. The process stops if there is no match or if communication between user and company is established.

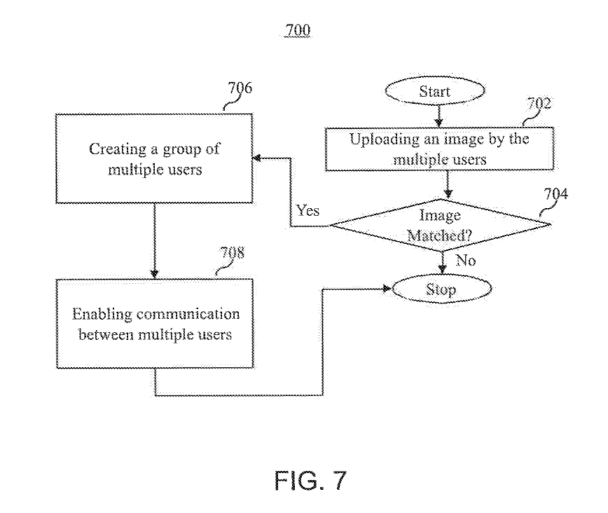

FIG. 7 discloses a step wise flow 700 in accordance with another embodiment of the present invention, where multiple users (more than two users) interact with each other without sharing their personal contact information by using an application program running on user devices. Process starts at step 702, where multiple users uploads the same image on the remote server by using application program running on the user devices. The image can be shared between the users by methods known in art or by using the aforementioned image sharing techniques. After the image is uploaded to the remote server, image is compared using Image Recognition Service (IRS). The IRS evaluates if images uploaded by multiple users are exactly similar at step 704. If there is exact match, then process goes to step 706 where a group is created. Only those users who have uploaded the same image are allowed in the group. After the group is created, the communication between the multiple users is enabled at step 708. The process stops if the uploaded images do not match or if communication between users is established.

In an embodiment, the image can be a group image of the multiple users wherein the remote server recognizes the faces of users in the image using face recognition methods and establish a connection between the users present in the group image.

In one embodiment of the present invention, the images used for establishing the connection can be substantially same. The IRS compares if the images are considerably similar i.e. the images are not exactly same but there is a substantial similarity between the images. For example, if result of comparison of two images is above a certain threshold value, then communication can be established. Threshold value can be used to mitigate or compensate the effect of minor differences in the images while matching. Differences in the images can be such as, but not limited to, minor color variations, change in orientation of the images, pixel differences due to compression or transmission of images, angle variations, etc.

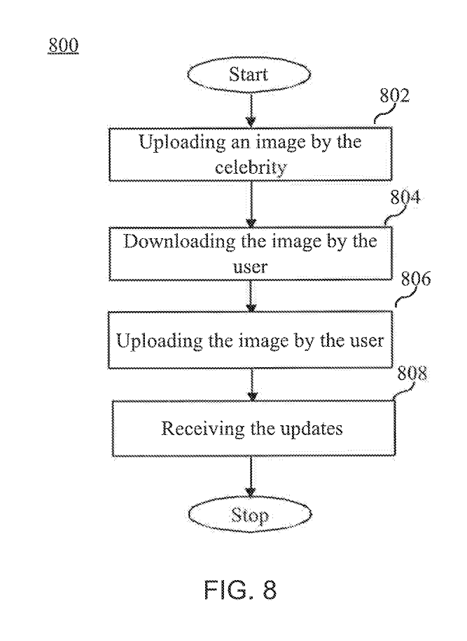

FIG. 8 shows the flow diagram of another embodiment of the present invention, where a famous person or celebrity uses the method of the present invention for connecting with their fans and followers. Process begins at step 802, where the celebrity uploads the image on the remote server using the application program running on the user device associated with the celebrity. At step 804, a user can download the image uploaded by the celebrity using the internet. Image can also be downloaded from, but not limited to, social profiles, professional profiles, blogs, magazines, and news articles. Further, the celebrity posts the image on his social profile like Facebook/Twitter and user can download it from there. After downloading the image flow proceeds to step 806 where user uploads this image to the remote server. The remote server evaluates whether uploaded images is the exactly same as the image uploaded by the celebrity. Once the result of evaluation is positive, the user receives the updates and promotional contents from the celebrities, in step 808. For example, celebrity can make a banner of his upcoming movie in the form of an image and the same image can be used by the fans and followers to upload the image to get all the updates regarding the movie.

In one embodiment of the present invention, the images are substantially similar to each other. For example, if result of comparison is above some threshold value, then communication can be established. Threshold value can be used to mitigate or compensate the effect of minor differences in the images while matching. Differences in the images can be such as, but not limited to, minor color variations, change in orientation of the images, pixel differences due to compression or transmission of images, angle variations, etc.

In another embodiment of the present invention, a company promotes their brand or products using the similar method mentioned above in accordance with FIG. 8.

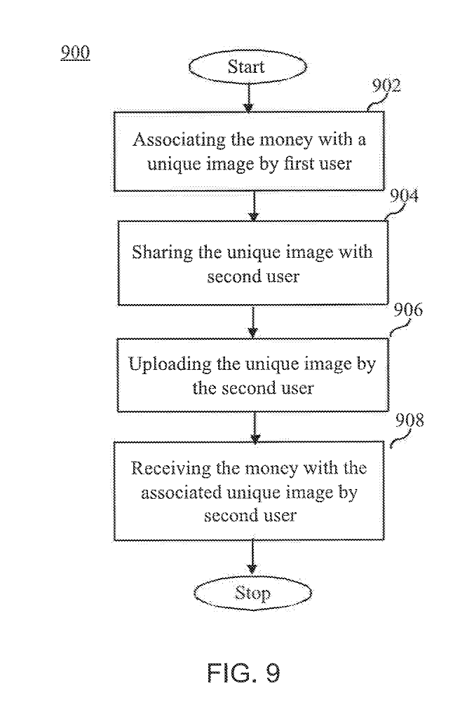

FIG. 9 shows the flow diagram for sending the money by a user in accordance with the present invention. Process starts at step 902, where a first user associates money with a unique image, wherein the step of associating includes linking a certain monetary amount (electronic money) with the unique image by using digital wallet, net banking, or other similar methods. After associating money with the unique image, the first user shares the image with the second user, step 904. The method used for sharing are known in the art or aforementioned methods explained in the description can be used. The second user than uploads the received unique image to the remote server, as shown in step 906. When image is uploaded to the remote server, the second user receives money, step 908.

For example, if a user wants to transfer money to his relative or friend, the user can associate money with a unique image and can share the unique image with his relative or friend. After receiving the image, the relative of the user can upload the unique image to the remote server and can redeem the money associated with the image. Thus, the scope of the present invention also applicable to offer gift cards/vouchers to the family members, friends or other users.

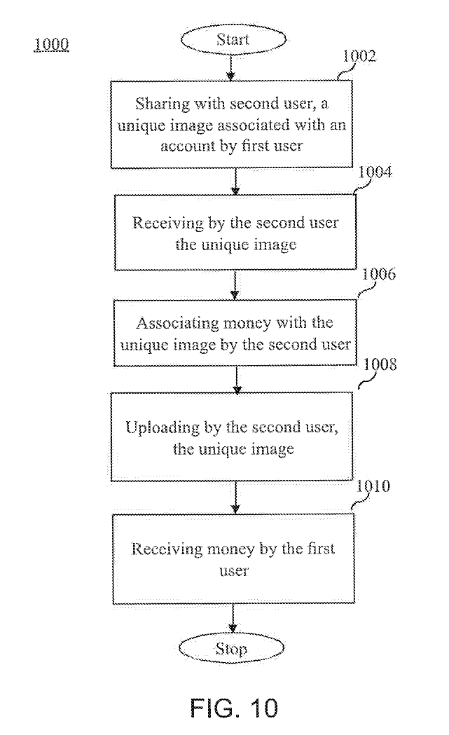

FIG. 10 shows the flow diagram of another embodiment for transferring money in accordance with the present invention. Process starts at step 1002, where a first user shares a unique image that is associated with the account of the first user. The account can be, such as, but not limited to, a bank account or a digital wallet account of the user. The method used for sharing are known in the art or aforementioned methods explained in the description can be used. The first user can be, but not limited to, a vendor, a friend, and/or a merchant. The second user receives the unique image at step 1004. After receiving the image, the second user associates money with the received unique image, step 1006. After associating the money in step 1006, the second user uploads the unique image to the remote server at step 1008. When image is uploaded to the remote server, the money that was associated with the unique image (in step 1006) is transferred to the account of first user as shown, in step 1010. It should be noted that the step 1006 of linking money with the image can be performed after the step 1008 of uploading the image to the remote server.

For example, a customer purchases a commodity from a vendor. The vendor has a unique image associated with his account. This image can be used as a virtual payment address to pay for the commodity. The vendor shares the unique image and the customer associates the price of commodity with the unique image. To make payment to the vendor, customer just have to upload the unique image and the vendor receives the money as soon as the image is uploaded on the remote server. It shall be noted that for implementing the embodiments as discussed in accordance with FIGS. 9 & 10, the application program running on the user device can also function as a digital wallet. Further, the functionality of the application program running on the user device can also be integrated with another digital wallet application program.

In another embodiment of the present invention, the method disclosed can be used for authentication of payments directly without using wallet. For example, user can transfer money from one bank account to another and the unique image can be used for authentication purpose. The method in present invention can also make payments using other methods as known in prior art.

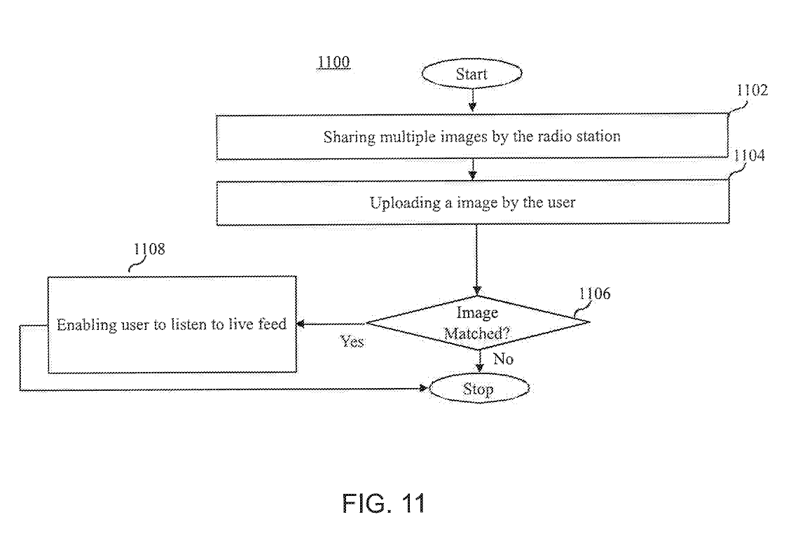

FIG. 11 discloses a method for connecting users to the live feed of the various radio/music stations according to the present invention as illustrated by flow 1100. At step 1102, the radio station uploads multiple images associated with various live feeds/podcasts on the remote server 130, wherein the received images are stored in the database 140 (as shown in FIG. 1). At step 1104, a user uploads an image associated with a radio channel using the user device 120. After uploading the image by the user, remote server 130 stores that image in its database 140. The image uploaded by the user is compared to the multiple images uploaded in the remote server. The comparison of images is achieved by Image recognition service 150 at step 1106. If there is a substantial similarity between the two images, then flow proceeds to step 1108. At 1108, a user is able to connected to the live feed/podcasts associated with the uploaded image and the user is able to listen to the live feed of the radio/music station. In accordance with the another embodiment of the present invention, the user can also view the other live events, sports events, or video channels, etc. by using the process as mentioned in FIG. 11.

In another embodiment of the present invention, the method can be used for electronic voting. In this method, a user wishing to vote for a candidate can directly upload the image of the candidate to the remote server. In another embodiment, the user can upload the image of a contestant to the remote server to vote for that political party. The remote server compares the uploaded image by the user and if there is a match then vote is registered in favor of the said candidate. In an embodiment, an online survey can also be joined or submitted by using the similar method as described above.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner. Thus, scope of the invention is indicated by the following claims rather than by the foregoing description.

What is claimed is:

1. A system for connecting users, the system comprising:
a server;
a first user device configured to upload a first image to the server; and
a second user device configured to upload a second image to the server;
wherein the server is configured to:
receive the first image from the first user device,
receive the second image from the second user device,
compare the first image and the second image, and
establish a connection between the first user device and the second user device based on the comparison of the first image and the second image.

2. The system of claim 1, wherein the first image and the second image are same.

3. The system of claim 2, wherein the server is further configured to establish the connection upon determining that the first image and the second image are same.

4. The system of claim 1, wherein the first user device is further configured to share the first image with the second user device.

5. The system of claim 1, wherein the first user device is further configured to delete the first image from the server and/or the second user device is further configured to delete the second image from the server.

6. The system of claim 5, wherein the server is further configured to terminate the connection in response to deletion of the first image and/or the second image from the server.

7. The system of claim 1 further comprising a third user device configured to upload a third image to the server.

8. The system of claim 7, wherein the server is further configured to:
compare the third image with the first image and the second image, and
establish a connection between the first user device, the second user device, and the third user device based on the comparison of the first image, the second image, and the third image.

9. A computer implemented method for connecting users, wherein the method comprises:
uploading, by a first user device, a first image to a server;
receiving, by the server, the first image;
uploading, by a second user device, a second image to the server;
receiving, by the server, the second image;
comparing, by the server, the first image and the second image; and
establishing, by the server, a connection between the first user device and the second user device based on the comparison of the first image and the second image.

10. The method of claim 9, wherein the first image and the second image are same.

11. The method of claim 10 further comprises establishing, by the server, the connection upon determining that the first image and the second image are same.

12. The method of claim 9 further comprises sharing, by the first user device, the first image with the second user device.

13. The method of claim 9 further comprises:
deleting, by the first user device, the first image from the server, and/or
deleting, by the second user device, the second image from the server.

14. The method of claim 15 further comprises terminating, by the server, the connection in response to deletion of the first image and/or the second image from the server.

15. The method of claim 9 further comprises uploading, by a third user device, a third image to the server.

16. The method of claim 15 further comprises:
comparing, by the server, the third image with the first image and the second image, and
establishing, by the server, a connection between the first user device, the second user device, and the third user device based on the comparison of the first image, the second image, and the third image.

17. A non-transitory computer readable medium storing a computer code comprising instructions, which when executed by a processor of a server, causes the server to:
receive a first image from a first user device;
receive a second image from a second user device;
compare the first image and the second image; and
establish a connection between the first user device and the second user device based on the comparison of the first image and the second image.

18. The non-transitory computer readable medium of claim 17, wherein the first image and the second image are same.

19. The non-transitory computer readable medium of claim 18, wherein the computer code further comprises instructions, which when executed by the processor of the server, causes the server to establish the connection upon determining that the first image and the second image are same.

20. The non-transitory computer readable medium of claim 17, wherein the computer code further comprises instructions, which when executed by the processor of the server, causes the server to terminate the connection in response to deletion of the first image and/or the second image from the server.
